(19) United States
(12) Patent Application Publication
(10) Pub. No.: US 2004/0093221 A1
(43) Pub. Date: May 13, 2004

(54) Global project integration

(76) Inventor: Blaine K. Taylor, Superior, CO (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/289,737

(22) Filed: Nov. 7, 2002

(51) Int. Cl. G06F 17/60

(52) U.S. Cl. 705/1

(57) ABSTRACT

Disclosed are novel methods and apparatus for provision of efficient, effective, and/or flexible global project management. In accordance with an embodiment of the present invention, a method of integrating a project is disclosed. The method includes: defining the project, the project involving a plurality of geographically remote entities; identifying at least one executive management person assigned to the project; developing a workshop; and forming a plurality of teams from participants in the workshop. The plurality of teams may include a core team and at least one subteam. The core team and the subteam may have at least one member in common to, for example, enhance the communication among the plurality of teams.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright© 2002, Sun Microsystems, Inc., All Rights Reserved.

### FIELD OF INVENTION

The present invention generally relates to the field of project management. More specifically, an embodiment of the present invention provides a global team structure to address global project management issues.

### BACKGROUND OF INVENTION

With the movement to a more global society and corporate culture, it is evident that effective globalization of projects has become even more important to a company's success. For example, a company may require expertise from a large group of people before it can bring a product to the market place. In the computer industry, to bring a computer to the market, the appropriate hardware parts may need to be developed and put into an appropriate box. The appropriate software may have to be developed and installed on the computer prior to making the product available to the market place.

The teams involved with such projects may be spread across different buildings and campuses located around the world while working on a same project. To avoid having to deal with global project issues, a company interested in expertise from distant locations is required to convince a worker to move to a central location, deal with travel restrictions (such as visa requirements), and wait for the worker to move and settle into the central location. Accordingly, the costs associated with moving workers may be prohibitively high in addition to being time-consuming. If the global corporate entities are to continue utilizing expertise from distant locations without having to worry about issues associated with moving workers to a central location, effective project management is not merely an advantage but a requirement.

### SUMMARY OF INVENTION

The present invention, which may be implemented utilizing a general-purpose digital computer, in certain embodiments of the present invention, includes novel methods and apparatus to provide efficient, effective, and/or flexible global project management. In accordance with an embodiment of the present invention, a method of integrating a project is disclosed. The method includes: defining the project, the project involving a plurality of geographically remote entities; identifying at least one executive management person assigned to the project; developing a workshop; and forming a plurality of teams from participants in the workshop. The plurality of teams may include a core team and at least one subteam. The core team and the subteam may have at least one member in common to, for example, enhance the communication among the plurality of teams.

In accordance with another embodiment of the present invention, the method may include: defining a plurality of deliverables; approving the defined deliverables; and building a process corresponding to the approved deliverables.

In accordance with a further embodiment of the present invention, the method may include accepting the built process by designated members of the plurality of separate entities.

In accordance with yet another embodiment of the present invention, the workshop may include participants selected from a group comprising a global leader, a project manager, a geography or business unit representative, an IT representative, a process expert, and a subject matter expert.

In accordance with a different embodiment of the present invention, the designated members of the plurality of separate entities may be selected from a group comprising an executive sponsor, a global leader, a project manager, a global project owner, a business analyst, a subteam leader, an IT leader, a process expert, a subject matter expert, a decision maker, a communication specialist, a business unit representative, and an interested party.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which the present invention may be embodied;

FIG. 2 illustrates an exemplary integrated team structure 200 for a global project in accordance with an embodiment of the present invention;

FIG. 3 illustrates an exemplary global project management method 300 in accordance with an embodiment of the present invention;

FIG. 4 illustrates an exemplary global project management method 400 in accordance with an embodiment of the present invention;

FIG. 5 illustrates an exemplary method 500 for providing project support in accordance with an embodiment of the present invention;

FIG. 6 illustrates an exemplary method 600 for developing a global workshop in accordance with an embodiment of the present invention;

FIG. 7 illustrates an exemplary method 700 for selecting teams from workshop participants in accordance with an embodiment of the present invention;

FIG. 8 illustrates an exemplary method 800 for identifying and developing global deliverables in accordance with an embodiment of the present invention;

FIG. 9 illustrates an exemplary approval cycle method 900 in accordance with an embodiment of the present invention;

FIG. 10 illustrates an exemplary method 1000 for building and testing the global process/system in accordance with an embodiment of the present invention;

FIG. 11 illustrates an exemplary method 1100 for global acceptance, transition, and/or support in accordance with an embodiment of the present invention; and

FIG. 12 illustrates an exemplary global project approval configuration 1200 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

Also, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, optical disks, compact disc-read only memories (CD-ROMs), and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data.

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

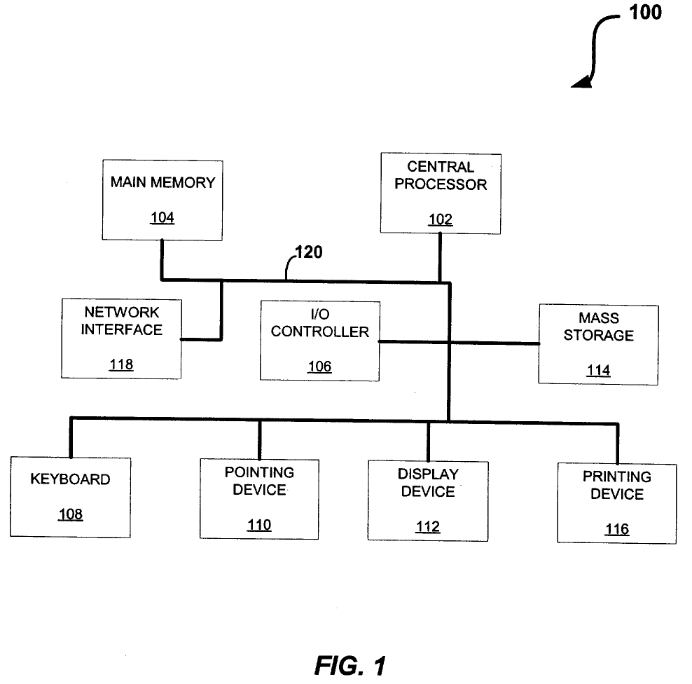

FIG. 1 illustrates an exemplary computer system 100 in which the present invention may be embodied in certain embodiments. The system 100 comprises a central processor 102, a main memory 104, an input/output (I/O) controller 106, a keyboard 108, a pointing device 110 (e.g., mouse, track ball, pen device, or the like), a display device 112, a mass storage 114 (e.g., a nonvolatile storage such as a hard disk, an optical drive, and the like), and a network interface 118. Additional input/output devices, such as a printing device 116, may be included in the system 100 as desired. As illustrated, the various components of the system 100 communicate through a system bus 120 or similar architecture.

In accordance with an embodiment of the present invention, the computer system 100 includes a Sun Microsystems computer utilizing a SPARC microprocessor available from several vendors (including Sun Microsystems, Inc., of Santa Clara, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a representative(s), or sales representative(s). The team structure 200 also includes a group of workshop participants 204 which may include any combination of the following, for example: global leader, project manager, geography 1 or business unit 1 representative(s), geography 2 or business unit 2 representative(s), geography 3 or business unit 3 representative(s), IT representative(s), process expert(s), or subject matter expert(s). In one embodiment of the present invention, the process matter and/or subject matter experts are selected to ensure that there are no gaps present in coverage of entities involved with the project.

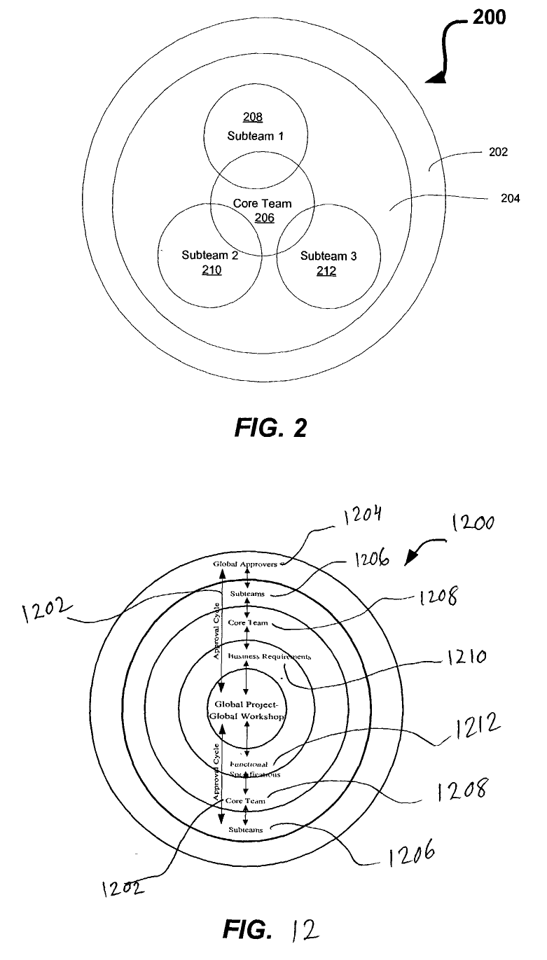

Furthermore, the team structure 200 may include a core team 206 and/or subteams 1-3 (208-212). The core team 206 may include any combination of the following, for example: global leader, project manager, business analyst, subteam 1 leader, subteam 2 leader, subteam 3 leader, IT leader, process expert(s), subject matter expert(s), decision maker, or communication specialist. The subteams 1-3 (208-212) may include any combination of the following, for example: subteam leader (may also participate on the core team), process expert(s), or subject matter expert(s). Moreover, the IT team resources may include any combination of the following, for example: IT leader (may also participate on the core team), development manager, code developer(s), or IT business analyst. As illustrated in FIG. 2, the core team 206 and subteams 1-3 (208-212) may be subunits of the workshop participants 204. Moreover, there may be overlap between the core team 206 and each of the subteams 1-3 (208-212) to enhance communication between the different entities involved. In accordance with an embodiment of the present invention, the overlap between the teams may be especially helpful for situations where the teams are geographically remote to enhance inter-group and/or intra-group communication, for example.

In an embodiment of the present invention, it is envisioned that the subteams 1-3 (208-212) may be associated with the geography 1-3 or business units 1-3, respectively. Also, even though a leader, analyst, decision maker, specialist, manager, and the like may be suggested herein as being a single person, it is envisioned that the functions of the single person may be delegated to a plurality of people (such as a committee) in various embodiments of the present invention. Furthermore, even though the discussion herein may refer to a specific number of geographies, business units, or subteams, it is envisioned that there may be larger or smaller numbers of such entities involved, and the number three is merely for exemplary purposes.

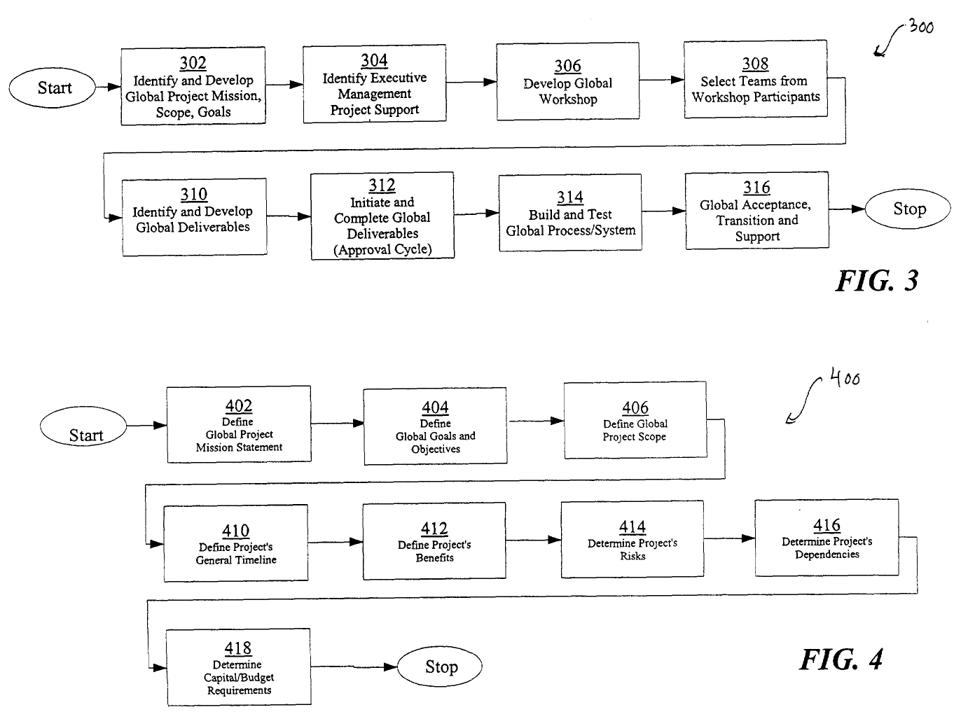

FIG. 3 illustrates an exemplary global project management method 300 in accordance with an embodiment of the present invention. The method 300 starts with a stage 302 which identifies and develops a global project mission, scope, goals, vision, and the like. For example, the stage 302 may limit or prevent mission or scope creep, for example, where multiple organizations may have competing interests.

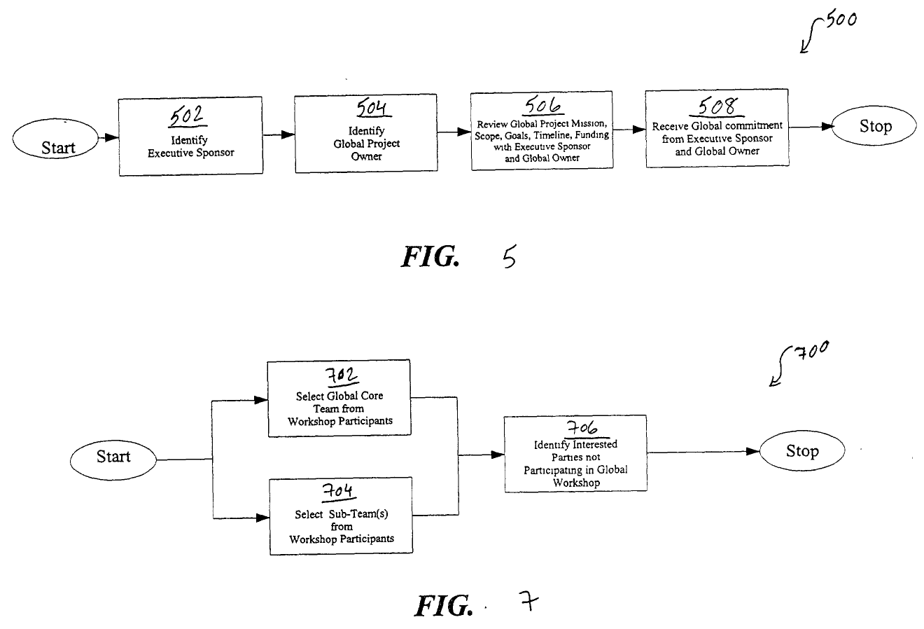

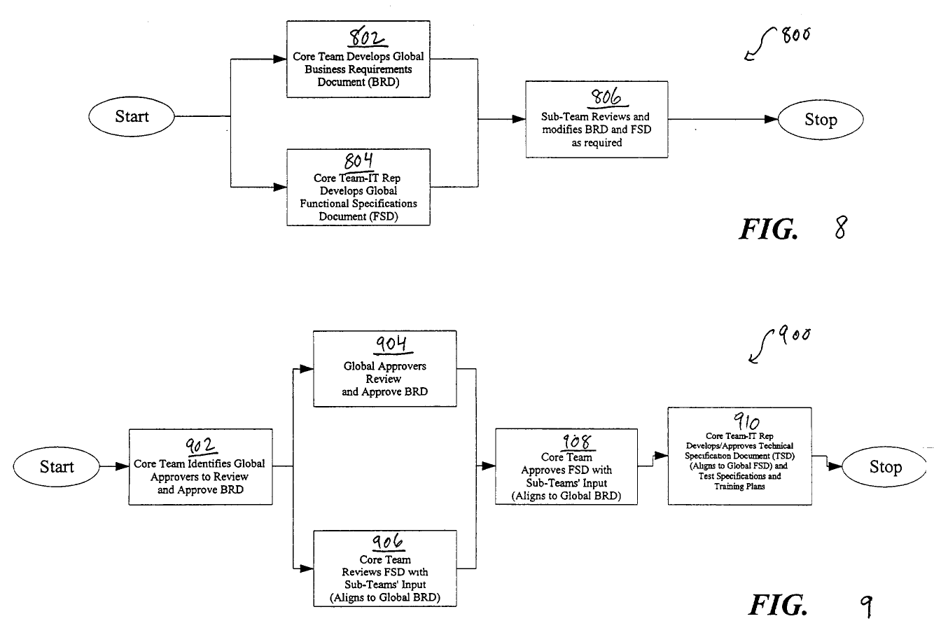

In a stage 304 the executive management for project support. A stage 306 develops the global workshop to determine business requirements (such as discussed with reference to FIG. 6). A stage 308 selects the teams from the global workshop participants (such as those discussed with respect to FIG. 2). In a stage 310, the global project deliverables are identified and developed. The deliverables may include items such as those discussed with reference to FIG. 8. A stage 312 (also referred to as an approval cycle) initiates and completes the global deliverables. In a stage 314, the global process or system are built and tested. The method 300 terminates in a step 316 which involves global acceptance, transition, and support of the global project at hand.

FIG. 4 illustrates an exemplary global project management method 400 in accordance with an embodiment of the present invention. In accordance with an embodiment of the present invention, the stage 302 of FIG. 3 may be implemented utilizing the method 400. The method 400 starts in a stage 402 which defines the global project mission statement. The global project mission statement may build links among organizations that touch the project. A stage 404 defines the global goals and/or objectives. A stage 406 defines the global project scope such as the boundaries of the project. In a stage 410, the general timeline of the project is defined. A stage 412 defines the project's benefits such as cost savings, increased efficiency, increased revenue, meeting governance requirements, and the like (with some quantitative values in an embodiment of the present invention). A stage 414 determines the possible risks associated with the project such as lost profits if the project does not progress as set forth by the stage 410 for example. In a stage 416, it is determined what the project dependencies are such as time constraints, manpower, executive support, funding support, and the like. Finally, the method 400 terminates in a stage 418 which determines the capital and/or budget requirements of the project. The capital and/or budget requirements may include detailed information as to, for example, the man hours necessary to complete each stage of the project and/or the costs associated with certain benefits and/or risks (such as those discussed with respect to the stages 412 and 414, respectively).

FIG. 5 illustrates an exemplary method 500 for providing project support in accordance with an embodiment of the present invention. In accordance with an embodiment of the present invention, the stage 304 of FIG. 3 may be implemented utilizing the method 500. The method 500 starts with a stage 502 which identifies the executive sponsor. It is envisioned that the executive sponsor may be the vice-president of a division within a company or otherwise a person with global executive responsibilities that has the ability to approve global project deliverables and/or resources. A stage 504 identifies the global project owner who may be a director of a global organization that owns the project. In a stage 506, the global project mission, scope, goals, timeline, or funding are reviewed with the executive sponsor and the global owner to ensure that the project stays focused on its priorities, for example. The method 500 terminates in a step 508 which involves receiving global commitment from the executive sponsor and the global owner. Such commitment may ensure that the executive sponsor and the global owner are held accountable for the successful project progression.

FIG. 6 illustrates an exemplary method 600 for developing a global workshop in accordance with an embodiment of the present invention. In accordance with an embodiment of the present invention, the stage 306 of FIG. 3 may be implemented utilizing the method 600. The method 600 starts with a stage 602 in which the global leader identifies the global workshop participants, time, location, and/or itinerary of the global workshop. In one embodiment, the global leader may be identified as discussed with respect to FIG. 5. In a stage 604, the global leader may develop and distribute workshop pre-work review material to the identified global workshop participants (of the stage 602). The global leader develops and reviews the participants' guidelines for the workshop with the global participants attending the workshop in a stage 606. In a stage 608, the workshop participants review the mission, scope, goals, deliverables, and/or the global critical success factors with each other.

In one embodiment, the global critical success factors may include any combination of the following: common goal/vision, commitment, control, centralization, communication, continued measurement & monitoring, constraints, costs, cultural, crisis management, and/or customer/client. The common goal/vision may include any combination of the following: global mission, vision, scope and goals, global initiative, and/or global consensus or “decide and commit.” The commitment may involve any combination of the following: executive sponsorship, geography/business unit participation, HQ participation, IT participation (e.g., tools and technology availability), core team individuals, funding, and/or training. The control factor may include factors associated with any combination of the following: project owner, global leader (e.g., project manager and/or business analyst), and/or subteam leaders. The centralization factor may involve issues regarding any combination of the following: core team, subject matter experts, decision makers, global approvers, project plan, and/or standardization (for example, of the global system and/or the global process).

In an embodiment of the present invention, the communication factor may involve any combination of the following factors: early and often, and/or all functional levels that touch the process (e.g., voicemail, electronic mail (Email), video-conference calls, presentations, and/or face-to-face meetings). The crisis management factor may involve any combination of the following: project plan deviation, issue escalation to the executive sponsor, and/or risk management. The constraints factor may include none or minimal amounts of the following: travel allowed, process experts, project manager, business analyst, subject matter experts, decision makers, communication specialist, consultants, funding/budget, and/or time. The cultural factors may involve differences associated with time-zone/geography, language/dialect, and/or political/religious. The continued measurement and monitoring may involve any combination of the following: audit of the process performance (e.g., at the global level, at the geographical level, and/or at the local level), quality assurance plan, global review of the deliverables (especially, the major deliverables), and/or user testing of the global process/system. The costs factor may involve any combination of the following: return on investment (ROI) analysis, net present value (NPV) or payback analysis, increasing revenue, reducing costs, identification of loss leader, and/or regulations (such as governmental ones). And, the customer/client factor may involve issues such as consultation, communication, review/approval of project plan, review at major or determined milestones, and/or review/approval at project completion.

In a stage 610, the workshop participants develop the business process descriptions for each major geographic region or business unit. In a stage 612, the workshop participants review the current systems, tools, interfaces, and/or technologies applicable to the global project implementation. In a stage 614, the workshop participants define the global business requirements, global business process, and initiate the functional specifications of the global project. In a stage 616, the workshop participants identify and address the business benefits, risks, training, funding, and/or testing issues. The method 600 terminates in a stage 618 wherein the workshop participants develop a detailed project plan including, for example, major milestones, identification of a critical path, project timelines, and the like. In accordance with an embodiment of the present invention, the stage 614 may identify one or more of the following: lines of business affected, geographic locations impacted, systems/tools/interfaces affected, product types affected, and/or mandatory requirements (e.g., Governance).

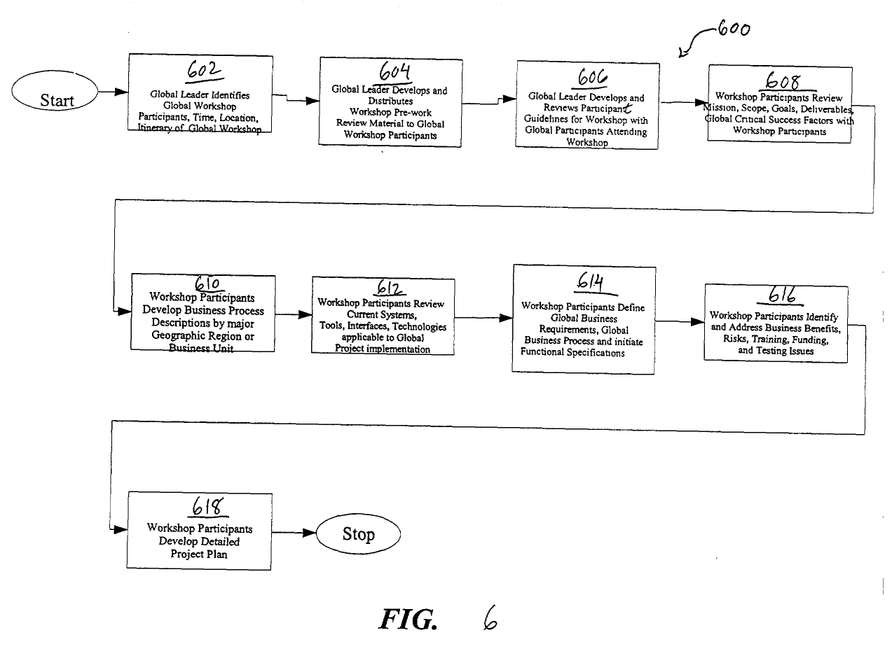

FIG. 7 illustrates an exemplary method 700 for selecting teams from workshop participants in accordance with an embodiment of the present invention. In accordance with an embodiment of the present invention, the stage 308 of FIG. 3 may be implemented utilizing the method 700. The method 700 starts with a stage 702 for selecting global core team from the workshop participants (such as those discussed with respect of FIG. 2). The method 700 may also simultaneously with the stage 702 (or at a different time) select subteam(s) from among the workshop participants in a stage 704. The method 700 terminates in a stage 706 by identifying interested parties not participating in the global workshop.

FIG. 8 illustrates an exemplary method 800 for identifying and developing global deliverables in accordance with an embodiment of the present invention. In accordance with an embodiment of the present invention, the stage 310 of FIG. 3 may be implemented utilizing the method 800. The method 800 starts with a stage 802 in which the core team (e.g., as determined with respect to the method 700) develops a global business requirements document (BRD) detailing the business requirements associated with the project. In a stage 804, either simultaneously with the stage 802 or at a different time, the core team IT representative(s) develops the global functional specifications document (FSD). The method 800 terminates in a stage 806 by the subteam(s) reviewing and modifying the BRD and/or FSD as required.

FIG. 9 illustrates an exemplary approval cycle method 900 in accordance with an embodiment of the present invention. In accordance with an embodiment of the present invention, the stage 312 of FIG. 3 may be implemented utilizing the method 900. Moreover, the method 900 may be utilized for initiating and/or completing the global deliverables such as those discussed with respect to FIG. 3. The method 900 starts with a stage 902 in which the core team (e.g., as determined with respect to the method 700) identifies the global approvers to review and approved the BRD (such as discussed with respect to FIG. 8). In a stage 904, the global approvers review and approved the BRD. In a stage 906, either simultaneously with the stage 904 or at a different time, the core team reviews the FSD (with subteams' input in an embodiment of the present invention). The stage 906 may ensure that the FSD is aligned with the global BRD. In a stage 908, the core team approves the FSD with subteams' input. The method 900 terminates in a stage 910 wherein the core team's IT representative(s) develop and/or approve the technical specification document (TSD) (i.e., align to global FSD) and test specifications and training plans.

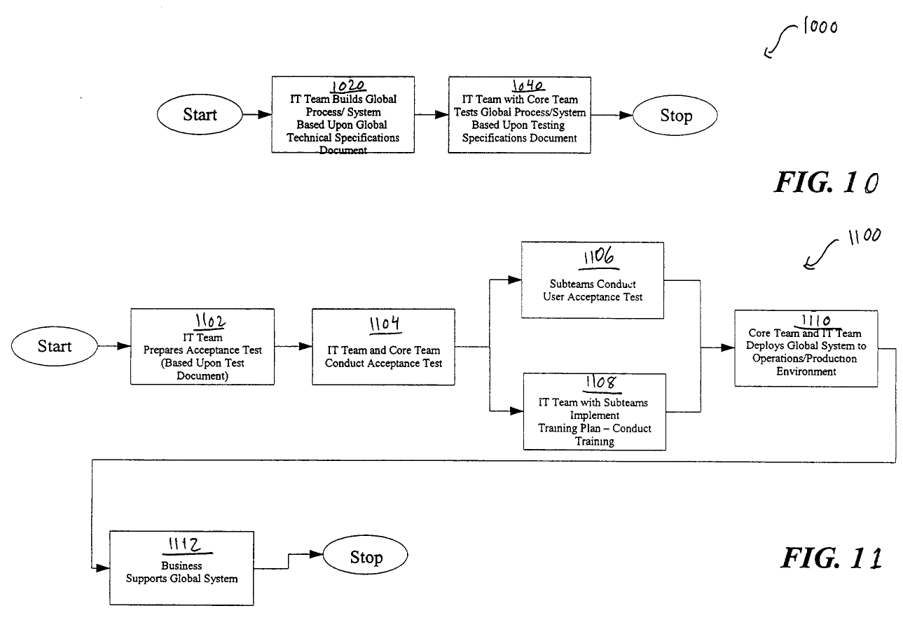

FIG. 10 illustrates an exemplary method 1000 for building and testing the global process/system in accordance with an embodiment of the present invention. In accordance with an embodiment of the present invention, the stage 314 of FIG. 3 may be implemented utilizing the method 1000. The method 1000 starts with a stage 1020 wherein the IT team (such as that discussed with respect to FIG. 2) builds the global process/system based upon, for example, the global TSD (such as that discussed with respect to FIG. 9). The method 1000 terminates in a stage 1040 wherein the IT team (e.g., together with the core team) tests the global process/system based upon, for example, a testing specifications document (which may be developed by the stage 910 of FIG. 9 in an embodiment of the present invention). The testing specification document may be developed by the IT team and include details regarding system development testing procedures (e.g., included in test scripts in accordance with an embodiment of the present invention). In one embodiment of the present invention, the stage 1040 may include user acceptance testing (UAT) by, for example, a subset of users.

FIG. 11 illustrates an exemplary method 1100 for global acceptance, transition, and/or support in accordance with an embodiment of the present invention. In accordance with an embodiment of the present invention, the stage 316 of FIG. 3 may be implemented utilizing the method 1100. The method 1100 starts with a stage 1102 in which the IT team prepares an acceptance test (for example, based on the test document discussed with respect to FIG. 10). In a stage 1104, the IT team and/or core team conduct the acceptance test of the stage 1102. In accordance with an embodiment of the present invention, the core team may be involved in the stage 1104 because it represents all the entities touched by the global project.

In a stage 1106, the subteams conduct user acceptance test to, for example, ensure that the user(s) are globally identified and participate in testing the global process and/or system. In a stage 1108, either simultaneously with the stage 1106 or at a different time, the IT team with subteams implement the training plan (i.e., conduct the training). In a stage 1110, the core team and/or the IT team are responsible for the transfer of the global project and/or system to the operations/production environment. The method 1100 terminates in a stage 1112 wherein the business supports the global system to meet the goals, for example, determined in the stage 302 of FIG. 3.

FIG. 12 illustrates an exemplary global project approval configuration 1200 in accordance with an embodiment of the present invention. As illustrated, a global project and its associated workshop 1201 may be approved through approval cycles 1202. For business requirements 1210 (such as those discussed herein with respect to other figures), the approval cycle 1202 may involve communication amongst a variety of groups including global approver(s) 1204, subteams 1206, and core team 1208. For functional specifications 1212 (such as those discussed herein with respect to other figures), the approval cycle 1202 may involve communication amongst a variety of groups including the core team 1208 and subteam(s) 1206.

As members of each team may be located across the globe (e.g., in different time zones), utilizing a computer system such as that discussed with respect to FIG. 1 may be highly beneficial in accordance with an embodiment of the present invention. For example, Email may be utilized to communicate data to other team members and/or certain tasks (e.g., those discussed with respect to FIGS. 2-12) may be implemented by utilizing a computer system such as that discussed with respect to FIG. 1). Also, data files may be readily shared across a computer network amongst team members.

The foregoing description has been directed to specific embodiments of the present invention. It will be apparent to those with ordinary skill in the art that modifications may be made to the described embodiments of the present invention, with the attainment of all or some of the advantages. For example, the techniques of the present invention may be utilized for provision of advertisement, messages, product development/marketing, decision-making, prioritization processes, and the like. Also, even though vice-presidents or directors may be mentioned specifically herein, it is envisioned that any manager with sufficient authority may perform the same or similar functions. Therefore, it is the object of the appended claims to cover all such variations and modifications as come within the spirit and scope of the invention.

What is claimed is:

1. A method of integrating a project, the method comprising:
defining the project, the project involving a plurality of geographically remote entities;
identifying at least one executive management person assigned to the project;
developing a workshop;
forming a plurality of teams from participants in the workshop, the plurality of teams including a core team and at least one subteam, the core team and the subteam having at least one member in common to enhance the communication among the plurality of teams;
defining a plurality of deliverables;
approving the defined deliverables;
building a process corresponding to the approved deliverables; and
accepting the built process by designated members of the plurality of separate entities.

2. The method of claim 1 wherein the workshop includes participants selected from a group comprising a global leader, a project manager, a geography or business unit representative, an IT representative, a process expert, and a subject matter expert.

3. The method of claim 1 wherein the designated members of the plurality of separate entities are selected from a group comprising an executive sponsor, a global leader, a project manager, a global project owner, a business analyst, a subteam leader, an IT leader, a process expert, a subject matter expert, a decision maker, a communication specialist, a business unit representative, and an interested party.

4. The method of claim 1 wherein the plurality of geographically remote entities are located at geographically remote locations with differing characteristics selected from a group comprising cultural, language-based, and time-zone dependent characteristics.

5. The method of claim 1 further including testing the built process.

6. The method of claim 1 further including transitioning to and supporting the accepted process.

7. The method of claim 1 wherein the plurality of deliverables are selected from a group comprising a BRD, an FSD, a TSD, and a UAT.

8. The method of claim 1 wherein the project is defined by identifying and developing a plurality of specifics regarding the project selected from a group comprising mission, scope, and goal.

9. The method of claim 1 wherein the workshop participants review a plurality of factors selected from a group comprising common goal, common vision, commitment, control, centralization, communication, continued measurement, continued monitoring, constraints, costs, cultural, crisis management, customer, and client.

10. An article of manufacture for integrating a project, the article comprising:
a machine readable medium that provides instructions that, if executed by a machine, will cause the machine to perform operations including:
defining the project, the project involving a plurality of geographically remote entities;
identifying at least one executive management person assigned to the project;
developing a workshop;
forming a plurality of teams from participants in the workshop, the plurality of teams including a core team and at least one subteam, the core team and the subteam having at least one member in common to enhance the communication among the plurality of teams;
defining a plurality of deliverables;
approving the defined deliverables;
building a process corresponding to the approved deliverables; and
accepting the built process by designated members of the plurality of separate entities.

11. The article of claim 10 wherein the workshop includes participants selected from a group comprising a global leader, a project manager, a geography or business unit representative, an IT representative, a process expert, and a subject matter expert.

12. The article of claim 10 wherein the designated members of the plurality of separate entities are selected from a group comprising an executive sponsor, a global leader, a project manager, a global project owner, a business analyst, a subteam leader, an IT leader, a process expert, a subject matter expert, a decision maker, a communication specialist, a business unit representative, and an interested party.

13. The article of claim 10 wherein the plurality of geographically remote entities are located at geographically remote locations with differing characteristics selected from a group comprising cultural, language-based, and time-zone dependent characteristics.

14. The article of claim 10 wherein the operations further include testing the built process.

15. The article of claim 10 wherein the operations further include transitioning to and supporting the accepted process.

16. The article of claim 10 wherein the plurality of deliverables are selected from a group comprising a BRD, an FSD, a TSD, and a UAT.

17. The article of claim 10 wherein the project is defined by identifying and developing a plurality of specifics regarding the project selected from a group comprising mission, scope, and goal.

18. The article of claim 10 wherein the workshop participants review a plurality of factors selected from a group comprising common goal, common vision, commitment, control, centralization, communication, continued measurement, continued monitoring, constraints, costs, cultural, crisis management, customer, and client.

19. A computer system for integrating a project, the system comprising:
means for defining the project, the project involving a plurality of geographically remote entities;
means for identifying at least one executive management person assigned to the project;
means for developing a workshop;
means for forming a plurality of teams from participants in the workshop, the plurality of teams including a core team and at least one subteam, the core team and the subteam having at least one member in common to enhance the communication among the plurality of teams;
means for defining a plurality of deliverables;
means for approving the defined deliverables; and
means for building a process corresponding to the approved deliverables.

20. The computer system of claim 19 further including means for accepting the built process by designated members of the plurality of separate entities.
